(19) United States
(12) Patent Application Publication
(10) Pub. No.: US 2016/0178732 A1
(43) Pub. Date: Jun. 23, 2016

(54) RADAR DEVICE AND SIGNAL PROCESSING METHOD

(71) Applicant: FUJITSU TEN LIMITED, Kobe-shi (JP)

(72) Inventors: Kenji OKA, Kobe-shi (JP); Takashi MATSUSHITA, Kobe-shi (JP); Kunihiro GOTO, Kobe-shi (JP); Hideaki NIIRO, Kobe-shi (JP)

(73) Assignee: FUJITSU TEN LIMITED, Kobe-shi (JP)

(21) Appl. No.: 14/971,275

(22) Filed: Dec. 16, 2015

(30) Foreign Application Priority Data
Dec. 19, 2014 (JP) 2014-257182

(51) Int. Cl. G01S 7/35; G01S 13/86; G01S 13/58

(52) U.S. Cl. CPC G01S 7/35; G01S 7/352; G01S 13/58; G01S 13/86

(57) ABSTRACT

A radar device includes: a receiving circuit mixing a transmission signal with reception signals; a first detecting unit detecting information on the rotation angle of a vehicle equipped with the radar device, on the basis of an output signal of a yaw rate sensor; a second detecting unit detecting the internal temperature of the radar device on the basis of an output signal from a temperature sensor; a power supply circuit supplying electric power to the receiving circuit and the yaw rate sensor; and a control unit repeatedly setting power supply periods and power supply stop periods of the receiving circuit, in which, in a case where the internal temperature is equal to or lower than a predetermined temperature, the control unit performs control such that the power supply stop periods of the receiving circuit become shorter than those in a case where the internal temperature exceeds the predetermined temperature.

### CROSS-REFERENCE TO RELATED APPLICATIONS

This application is based on and claims priority under 35 USC 119 from Japanese Patent Application No. 2014-257182 filed on Dec. 19, 2014, the entire content of which is incorporated herein by reference.

### BACKGROUND

1. Technical Field

The present invention relates to transmission/reception control of a radar device.

2. Related Art

In general, a radar device outputs a transmission wave to the outside of the radar device, and receives reflected waves of the transmission wave from targets, and derives target information items such as the locations of the targets, on the basis of reception signals corresponding to the reflected waves.

In the case where the radar device performs a target information deriving process as described above, a power supply circuit supplies electric power to individual internal devices of the radar device. For example, the power supply circuit supplies electric power to individual devices such as a monolithic microwave integrated circuit (MMIC) for transmission, an MMIC for reception, and a yaw rate sensor.

The MMIC for transmission (hereinafter, referred to as the “transmission IC”) is a device which mainly generates a transmission signal corresponding to the transmission wave, and the MMIC for reception (hereinafter, referred to as the “reception IC”) is a device which mainly mixes the transmission signal and reception signals. Therefore, if the power supply circuit supplies electric power to the transmission IC and the reception IC, a transmission signal can be generated, and the transmission signal and reception signals can be mixed.

In contrast to this, while a signal processing unit of the radar device performs the target information deriving process, supply of electric power to the transmission IC and the reception IC is stopped. For example, switches are provided between the power supply circuit and the individual ICs, respectively, and supply of electric power to the transmission IC and the reception IC is controlled by switching on or off those switches.

In this case, if the switches provided between the power supply circuit and the ICs are switched on or off, the output voltage of the power supply circuit changes. Further, the change of the output voltage influences the amplitude of an output signal of the yaw rate sensor. As a result, the output signal of the yaw rate sensor also changes. Also, the power supply circuit is connected to an electrolytic capacitor, which has a characteristic that its impedance at low temperature (for example, −30° C.) is higher than that at high temperature (for example, +30° C.). Therefore, the output voltage at low temperature relatively significantly changes with respect to a small amount of change in current. Due to this change of the output voltage, the output signal of the yaw rate sensor also changes relatively significantly.

Also, according to the temperature characteristic of the yaw rate sensor, the amplitude of the output signal of the yaw rate sensor changes. Specifically, the amplitude of the output signal of the yaw rate sensor changes according to the internal temperature of the radar device. For example, in a case where the actual angular velocity of a vehicle based on the output signal of the yaw rate sensor is 0.6 deg/sec, when the internal temperature of the radar device is −10° C., for example, 0.5 deg/sec is detected as the angular velocity. Also, when the internal temperature of the radar device is +10° C., for example, 0.7 deg/sec may be detected as the angular velocity. Further, this difference between the actual angular velocity and the angular velocity according to temperature depends on yaw rate sensors.

Therefore, the radar device sets, as a reference value, the angular velocity (for example, 0 deg/sec) based on the output signal of the yaw rate sensor when the vehicle is at a stop, and detects the actual angular velocity as a measurement value, and calculates a correction value on the basis of the difference between the reference value and the measurement value. The radar device performs so-called “zero-point level learning” as described above. Also, the radar device has a memory retaining correction values calculated with respect to various temperatures. When performing the target information deriving process, the radar device reads out a correction value according to the internal temperature of the radar device, from the memory, and corrects measurement values on the basis of the read correction value, thereby deriving the accurate locations of targets. Also, as a reference material describing a technology related to the present invention, there is JP-A-2010-122051.

### SUMMARY OF INVENTION

By the way, the temperature characteristic of the yaw rate sensor changes over time. Therefore, it is required to perform zero-point level learning at almost regular intervals. Also, while zero-point level learning or the target information deriving process is performed, if the switches for controlling supply of electric power to any one of the ICs are switched on or off, the output signal of the yaw rate sensor changes. Due to this change, the radar device may not calculate an appropriate correction value or may not derive the accurate locations of targets.

An illustrative aspect of the present invention is to acquire accurate information on angular velocity, on the basis of information from a power supply connected to MMICs and information from a yaw rate sensor connected to the power supply.

[1] An aspect of the present invention provides a radar device including: a receiving circuit that mixes a transmission signal with reception signals; a first detecting unit that detects information on a rotation angle of a vehicle equipped with the radar device, on the basis of an output signal of a yaw rate sensor; a second detecting unit that detects an internal temperature of the radar device on the basis of an output signal from a temperature sensor; a power supply circuit that supplies electric power to the receiving circuit and the yaw rate sensor; and a control unit that repeatedly sets power supply periods and power supply stop periods of the receiving circuit, in which, in a case where the internal temperature is equal to or lower than a predetermined temperature, the control unit performs control such that the power supply stop periods of the receiving circuit become shorter than those in a case where the internal temperature exceeds the predetermined temperature.

[2] It may be the radar device according to [1], in which: the receiving circuit has first switches which are switched on or off according to whether electric power is supplied to the receiving circuit, and in a case where the internal temperature is equal to or lower than the predetermined temperature, the control unit performs control such that OFF periods of the first switches become shorter than those in a case where the internal temperature exceeds the predetermined temperature.

[3] It may be the radar device according to [1] or [2], further including: a transmitting circuit that generates the transmission signal, in which the power supply circuit supplies electric power to the transmitting circuit, and the control unit repeatedly sets power supply periods and power supply stop periods of the transmitting circuit, in a case where the internal temperature is equal to or lower than a predetermined temperature, the control unit performs control such that the power supply stop periods of the transmitting circuit become shorter than those in a case where the internal temperature exceeds the predetermined temperature.

[4] It may be the radar device according to [3], in which: the transmitting circuit has second switches which are switched on or off according to whether electric power is supplied to the transmitting circuit, and in a case where the internal temperature is equal to or lower than the predetermined temperature, the control unit performs control such that OFF periods of the second switches become shorter than those in a case where the internal temperature exceeds the predetermined temperature.

[5] It may be the radar device according to [1], further including: a learning unit that learns a correction value for correcting information on the rotation angle, on the basis of information on the rotation angle detected by the first detecting unit, in which, in a case of learning the correction value, the control unit shortens the power supply stop periods of the receiving circuit.

[6] Another aspect of the present invention provides a signal processing method of a radar device which includes a receiving circuit that mixes a transmission signal with reception signals, a yaw rate sensor that has individual devices, and a power supply circuit that supplies electric power to the individual devices, including: a step (a) of detecting information on the rotation angle of a vehicle equipped with the radar device, on the basis of an output signal of the yaw rate sensor; a step (b) of detecting the internal temperature of the radar device on the basis of an output signal from a temperature sensor; and a step (c) of repeatedly setting power supply periods and power supply stop periods of the receiving circuit, in which, in the step (c), in a case where the internal temperature is equal to or lower than a predetermined temperature, the power supply stop periods of the receiving circuit are set so as to be shorter than those in a case where the internal temperature exceeds the predetermined temperature.

[7] Another aspect of the present invention provides a radar device including: a receiving circuit that mixes a transmission signal with reception signals; a first detecting unit that detects information on the rotation angle of a vehicle equipped with the radar device, on the basis of an output signal of a yaw rate sensor; a second detecting unit that detects the internal temperature of the radar device on the basis of an output signal from a temperature sensor; a power supply circuit that supplies electric power to the receiving circuit and the yaw rate sensor; and a control unit that repeatedly sets power supply periods and power supply stop periods of the receiving circuit, in which, in a case where the internal temperature is a specific temperature, the control unit performs control such that the power supply stop periods of the receiving circuit become shorter than those corresponding to the previous internal temperature.

According to any one of [1] to [7], even in a case where the internal temperature of the radar device is relatively low, the radar device can detect information on the rotation angle of the vehicle with a high degree of accuracy, and can derive the accurate locations of targets.

Also, according to any one of [1] to [7], even in a case where the internal temperature of the radar device is relatively low, since the radar device detects information on the rotation angle of the vehicle with a high degree of accuracy, the radar device can derive an appropriate correction value.

### BRIEF DESCRIPTION OF DRAWINGS

FIG. 1 is a view illustrating the configuration of a radar device.

FIG. 2 is a flow chart illustrating a zero-point level learning process

FIG. 3 is a graph illustrating an output signal of a yaw rate sensor.

FIG. 4 is a graph illustrating another output signal of the yaw rate sensor.

FIG. 5 is a graph illustrating change of another output signal of the yaw rate sensor according to the internal temperature of the radar device when a vehicle is at a stop.

FIG. 6 is a flow chart illustrating a power supply control process according to the internal temperature of the radar device.

FIG. 7 is a flow chart illustrating a power supply control process for low temperature.

FIG. 8 is a time chart illustrating timings to switch on or off switches.

FIG. 9 is a flow chart illustrating a power supply control process for high temperature.

FIG. 10 is a time chart illustrating timings to switch on or off the switches.

FIG. 11 is a time chart illustrating timings to switch on or off switches of a second embodiment.

### DESCRIPTION OF EMBODIMENTS

Hereinafter, embodiments of the present invention will be described with reference to the accompanying drawings.

### First Embodiment

<1. Block Diagram of Radar Device>

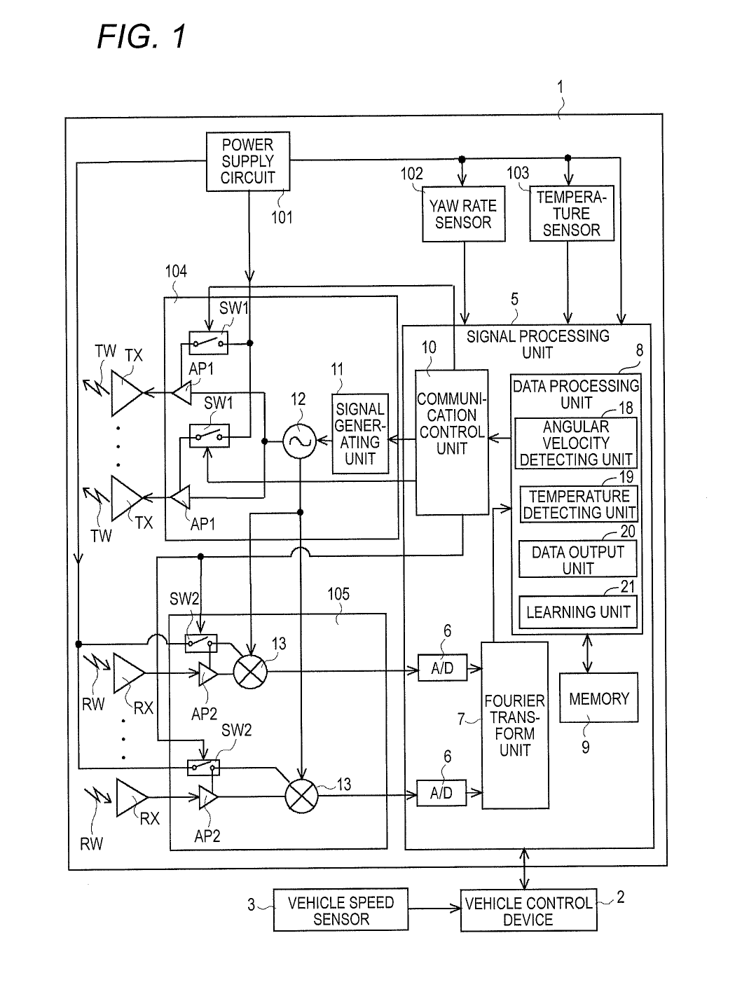

FIG. 1 is a view illustrating the configuration of a radar device 1. The radar device 1 is installed, for example, inside the front grille of a vehicle, and outputs transmission waves to the outside of the vehicle, thereby receiving reflected waves from targets. The radar device 1 derives targets existing around the vehicle, for example, by frequency-modulated continuous waves (FM-CWs).

Also, the radar device 1 is electrically connected to a vehicle control device 2. The vehicle control device 2 is connected to some components of the vehicle such as a brake and a throttle, and acquires target information items output from the radar device 1, and controls behavior of the vehicle.

Further, the vehicle control device 2 is electrically connected to a vehicle speed sensor 3. On the basis of the number of revolutions of the axle of the vehicle, the vehicle speed sensor 3 outputs a signal according to the speed of the vehicle, to the vehicle control device 2. The vehicle control device 2 detects the current speed of the vehicle on the basis of the signal from the vehicle speed sensor 3, and outputs the detected vehicle speed to the radar device 1.

The radar device 1 mainly includes a power supply circuit 101, a yaw rate sensor 102, a temperature sensor 103, an MMIC for transmission 104 (hereinafter, referred to as the transmission IC 104), an MMIC for reception 105 (hereinafter, referred to as the reception IC 105), and a signal processing unit 5.

The power supply circuit 101 is a device for supplying electric power to the yaw rate sensor 102, the temperature sensor 103, the transmission IC 104, and the reception IC 105. The power supply circuit 101 outputs a voltage, for example, 5 V, thereby driving each device such as the yaw rate sensor 102.

The yaw rate sensor 102 outputs information on the rotation angle of the vehicle equipped with the radar device 1. Specifically, the yaw rate sensor 102 outputs a signal representing the rate of change of the rotation angle (the angular velocity) in a direction to which the vehicle turns, to the signal processing unit 5.

The temperature sensor 103 detects the internal temperature of the radar device, and outputs information on the internal temperature of the radar device to the signal processing unit 5.

The transmission IC 104 is a device which mainly generates a transmission signal. The transmission IC 104 mainly includes a signal generating unit 11, an oscillator 12, amplifiers AP1, and switches SW1.

The signal generating unit 11 generates a modulation signal whose voltage varies in a triangular waveform, and supplies the modulation signal to the oscillator 12. The oscillator 12 performs frequency modulation on a continuous-wave signal on the basis of the modulation signal, thereby generating a transmission signal whose frequency changes over time, and outputs the transmission signal to the amplifiers AP1.

The amplifiers AP1 are provided for four transmitting antennae TX (to be described below), respectively. The amplifiers AP1 amplify the amplitude of the transmission signal, and output the transmission signal to the transmitting antennae TX.

Each of the switches SW1 is provided between the power supply circuit 101 and a corresponding one of the four amplifiers AP1. When the switches SW1 are on, electric power is supplied to the amplifiers AP1, and if the switches SW1 are switched off, supply of electric power to the amplifiers AP1 stops.

The transmitting antennae TX are antennae for outputting the transmission waves TW to the outside of the vehicle on the basis of the transmission signal. For example, the transmitting antennae TX are composed of four antennae. The transmission waves of the transmitting antennae TX are subsequently output in different directions.

Also, receiving antennae RX are antennae for receiving reflected waves. The receiving antennae RX are composed of four antennae. The receiving antennae RX receive reflected waves from a certain target, with phase differences according to the angles of the receiving antennae RX to the target.

The reception IC 105 is a device which mainly mixes the transmission signal with reception signals. The reception IC 105 mainly includes amplifiers AP2, mixers 13, and switches SW2.

The amplifiers AP2 are provided for the four receiving antennae RX, respectively. The amplifiers AP2 amplify the amplitudes of reception signals corresponding to reflected waves, and output the reception signals to the mixers 13.

The mixers 13 are provided in the next stage of the four amplifiers AP2, and mix the reception signals with the transmission signal output from the oscillator 12. As a result, beat signals having beat frequencies which are difference frequencies between the frequency of the transmission signal and the frequencies of the reception signals are generated. The mixers 13 output the beat signals to A/D converters 6 (to be described below).

Each of the switches SW2 is provided among the power supply circuit 101, a corresponding amplifier AP2, and a corresponding mixer 13. When the switches SW2 are on, electric power is supplied to the amplifiers AP2 and the mixers 13, and if the switches SW2 are switched off, supply of electric power to the amplifiers AP2 and the mixers 13 stops.

The signal processing unit 5 has the A/D converters 6, and a micro computer including a memory 9 and so on. The A/D converters 6 convert the analog beat signals output from the mixers 13, into digital signals, and output the digital signals to a Fourier transform unit 7.

The memory 9 is a memory device which stores a variety of data to be subjects of computing, and correction values (to be described below) for the yaw rate sensor 102. Examples of the memory 9 include an erasable programmable read only memory (EPROM) and a flash memory.

Also, the signal processing unit 6 includes the Fourier transform unit 7, a data processing unit 8, and a transmission/reception control unit 10, as functions which are implemented in a software wise by the micro computer. The Fourier transform unit 7 performs fast Fourier transform (FFT) on the beat signals. Thereby, the Fourier transform unit 7 converts the beat signals into frequency spectra which are frequency-domain data items. The frequency spectra obtained in the Fourier transform unit 7 are output to the data processing unit 8.

The data processing unit 8 derives target information items of targets, on the basis of the frequency spectra output from the Fourier transform unit 7, the information on the rotation angle of the vehicle which is output from the yaw rate sensor 102, the information on the internal temperature of the radar device which is output from the temperature sensor 103, and the like.

Specifically, the data processing unit 8 includes an angular-velocity detecting unit 18, a temperature detecting unit 19, a data output unit 20, and a learning unit 21, as functions. These functions are used to derive target information items of targets or to perform zero-point level learning.

The angular-velocity detecting unit 18 acquires the information on the rotation angle of the vehicle output from the yaw rate sensor 102, thereby detecting the angular velocity of the vehicle.

The temperature detecting unit 19 acquires the information on the internal temperature of the radar device output from the temperature sensor 103, thereby detecting the internal temperature of the radar device.

The data output unit 20 outputs a variety of information, such as the information on the internal temperature of the radar device detected by the temperature detecting unit 19, to the transmission/reception control unit 10.

The learning unit 21 performs zero-point level learning, thereby calculating a correction value depending on the internal temperature of the radar device, and stores the calculated correction value in the memory 9.

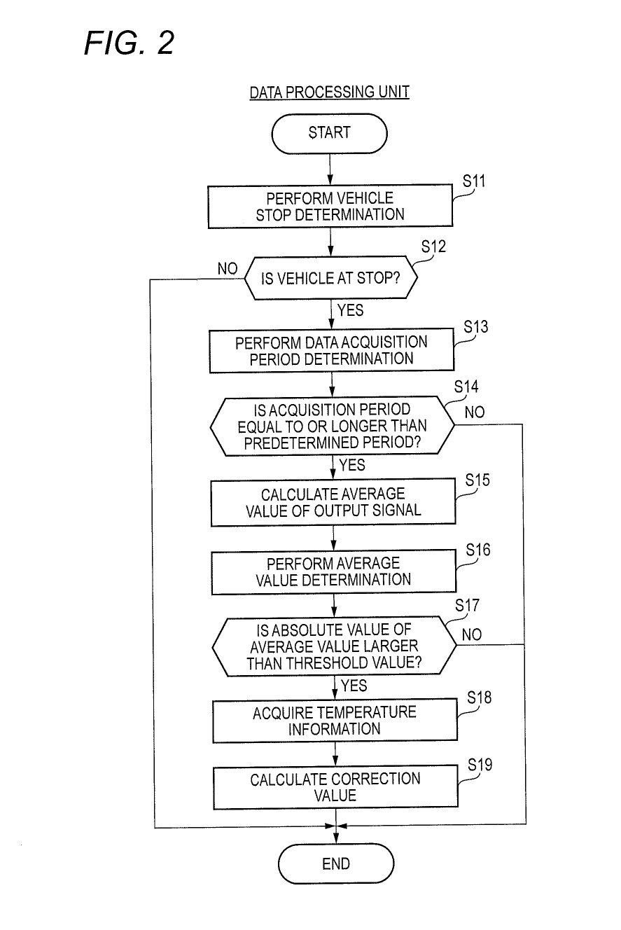

Now, a specific method of zero-point level learning which is performed by the learning unit 21, and the like will be described with reference to FIGS. 2 to 5. Zero-point level learning means to calculate a correction value for correcting a measurement value which is the angular velocity of the vehicle detected by the yaw rate sensor 102, on the basis of the difference between the measurement value and a reference value (for example, 0 deg/sec) which is the angular velocity when the vehicle is at a stop. As a correction value depending on the internal temperature of the radar device, the calculated correction value is stored in the memory 9.

<2. Zero-Point Level Learning Process>

FIG. 2 is a flow chart illustrating a zero-point level learning process. In STEP S11, the learning unit 21 determines whether the vehicle equipped with the radar device 1 is at a stop. In STEP S12, the learning unit 21 determines whether the vehicle is at a stop, for example, on the basis of the speed of the vehicle acquired from the vehicle speed sensor 3.

For example, in a case where the speed of the vehicle is 0 km/h (“Yes” in STEP S12), the learning unit 21 determines that the vehicle is at a stop. In this case, in STEP S13, the learning unit 21 determines whether the period of acquisition of data on the output signal from the yaw rate sensor 102 is equal to or longer than a predetermined period. The predetermined period is, for example, 20 sec.

In a case where the output signal acquisition period is equal to or longer than the predetermined period (“Yes” in STEP S14), in STEP S15, the learning unit 21 calculates the average value of the output signal. Meanwhile, in a case where the output signal acquisition period is shorter than the predetermined period (“No” in STEP S14), the learning unit 21 finishes the learning process.

Subsequently, in STEP S16, the learning unit 21 compares the absolute value of the average value calculated in the process of STEP S15, with the absolute value of a threshold value. In a case where the absolute value of the average value exceeds the absolute value of the threshold value (“Yes” in STEP S17), in STEP S18, the learning unit 21 acquires the information on the internal temperature of the radar device from the temperature sensor 103. Meanwhile, in a case where the absolute value of the average value is equal to or smaller than the absolute value of the threshold value (“No” in STEP S17), the learning unit 21 finishes the learning process.

After the information on the internal temperature of the radar device is acquired, in STEP S19, the learning unit 21 calculates a correction value, and stores the calculated correction value in the memory 9 in association with the corresponding temperature. The correction value is calculated, for example, on the basis of the difference between the reference value (0 deg/sec) and the average value. If there is a past correction value stored in association with the temperature detected in the current process, the learning unit 21 updates the past correction value with the new correction value calculated.

Therefore, when the radar device 1 performs a target information deriving process, the radar device can read out a correction value depending on the internal temperature of the radar device, from the memory, and correct measurement values of the output signal of the yaw rate sensor 102 by the read correction value, thereby capable of deriving the accurate locations of targets.

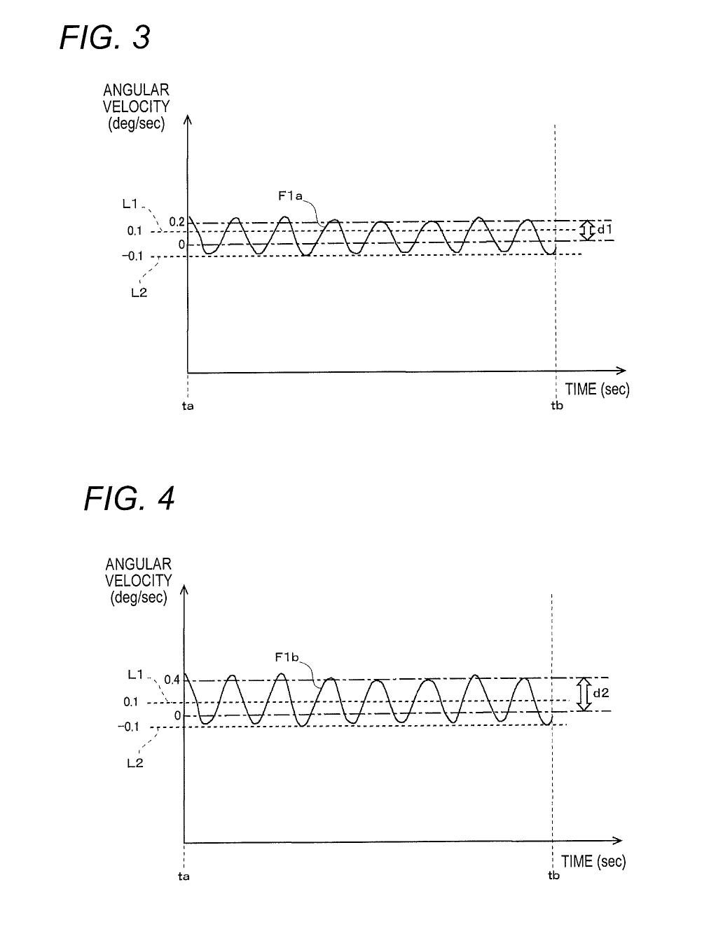

Now, correction value calculation will be described in more detail with reference to graphs of output signals of the yaw rate sensor 102. FIGS. 3 and 4 are graphs illustrating output signals of the yaw rate sensor 102. In FIGS. 3 and 4, each horizontal axis represents time (in sec), and each vertical axis represents angular velocity (in deg/sec). Also, FIGS. 3 and 4 show the transitions of the output signals in a period from a time ta to a time tb (for example, in a period of about 20 sec). Further, in FIGS. 3 and 4, a first threshold value L1 is, for example, +0.1 deg/sec, and a second threshold value L2 is, for example, −0.1 deg/sec. Therese threshold values are compared with an average value in STEP S17 described above.

The output signal F1a of FIG. 3 is a signal uninfluenced by switching of the switches SW2 of the reception IC 105. The learning unit 21 calculates the average value (for example, +0.2 deg/sec) of the output signal F1a in STEP S15.

Since the average value exceeds the first threshold value L1 (“Yes” in STEP S17), in STEP S19, the learning unit 21 calculates a correction value based on the difference d1 between the average value and the reference value (for example, 0 deg/sec). Thereafter, the learning unit 21 updates a correction value stored in association with the internal temperature (for example, −30° of the radar device detected in the current process, with the new correction value (for example, +0.2 deg/sec).

In contrast, the output signal F1b of FIG. 4 is a signal influenced by switching of the switches SW2 of the reception IC 105. Similarly in the process described with reference to FIG. 3, in STEP S15, the learning unit 21 calculates the average value (the average angular velocity, that is, +0.4 deg/sec) of the output signal F1b. In this case, since the average value exceeds the first threshold value L1 (“Yes” in STEP S17), in STEP S19, the learning unit 21 calculates a correction value based on the difference d2 between the average value and the reference value. Thereafter, the learning unit 21 updates a correction value stored in association with the internal temperature (for example, −30° of the radar device detected in the current process, with the new correction value (for example, +0.4 deg/sec).

As described above, if the output signal of the yaw rate sensor 102 changes due to influence of switching of the switches SW2 of the reception IC 105, a past correction value is updated with an inappropriate correction value.

The output signal of the yaw rate sensor 102 changes more significantly when the internal temperature of the radar device is relatively low than when the internal temperature of the radar device is relatively high. The power supply circuit 101 is connected to an electrolytic capacitor, and the impedance of the electrolytic capacitor is higher at low temperature (for example, −30° C.) than high temperature (for example, +30° C.), according to the temperature characteristic. Therefore, at low temperature, even with respect to a small amount of change in current, the output voltage relatively significantly varies, and the output signal of the yaw rate sensor also varies relatively significantly. Also, the magnitude of change of the output signal as described above is determined on the basis of the frequency of the output voltage of the power supply circuit 101 and the frequency of a crystal resonator included in the yaw rate sensor 102.

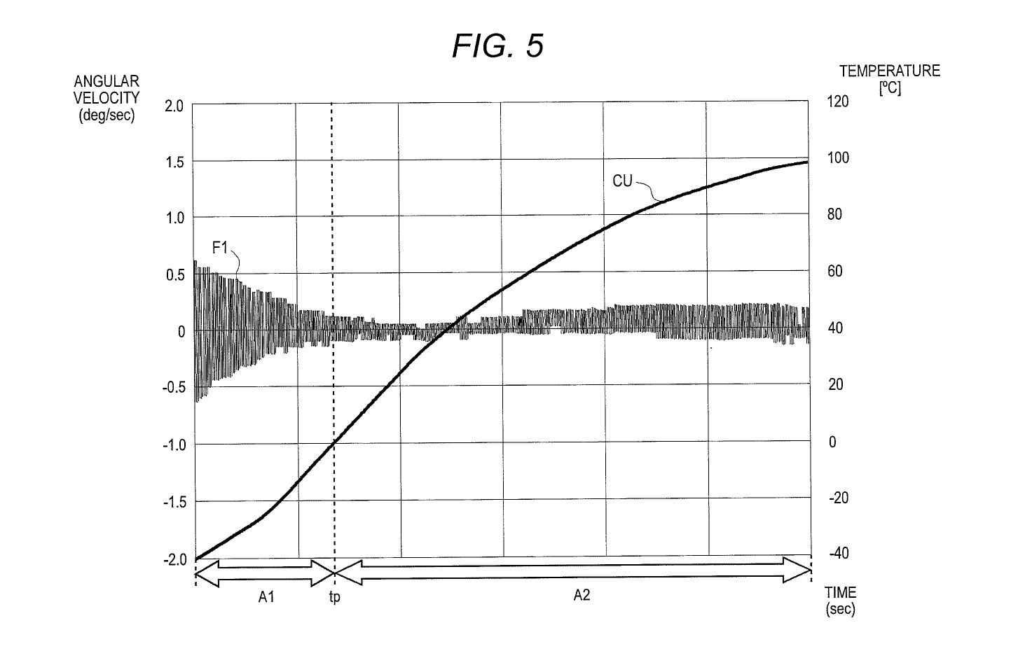

Now, a specific example of change of the output signal of the yaw rate sensor 102 according to temperature will be described. FIG. 5 is a graph illustrating change of the output signal according to the internal temperature of the radar device when the vehicle is at a stop. In this graph, the horizontal axis represents time (in sec), and vertical axes represent angular velocity (in deg/sec) and temperature (in ° C.). A temperature line CU represents change of the internal temperature of the radar device over time, and an output signal F1 shows change of the output signal of the yaw rate sensor 102.

From the graph of FIG. 5, it can be seen that, in a case where the internal temperature of the radar device is equal to lower than a predetermined temperature (for example, 0° C.), the amount of change of the output signal F1 is relatively large. In a section A1 before a time tp, the internal temperature of the radar device is equal to or lower than the predetermined temperature. Also, from the graph of FIG. 5, it can be seen that, in a case where the internal temperature of the radar device exceeds the predetermined temperature, the amount of change of the output signal F1 is relatively small. In a section A2 after the time tp, the internal temperature of the radar device exceeds the predetermined temperature.

Also, change of the output voltage of the power supply circuit 101 is influenced more by switching of the switches SW2 of the reception IC 105 than by switching of the switches SW1 of the transmission IC 104. The reason is that the power consumption of the reception IC 105 is larger than the power consumption of the transmission IC 104. By suppressing switching of the switches of the IC consuming a larger amount of electric power, it is possible to reduce change of the output voltage of the power supply circuit 101.

<3. Process of Suppressing Change of Output Signal>

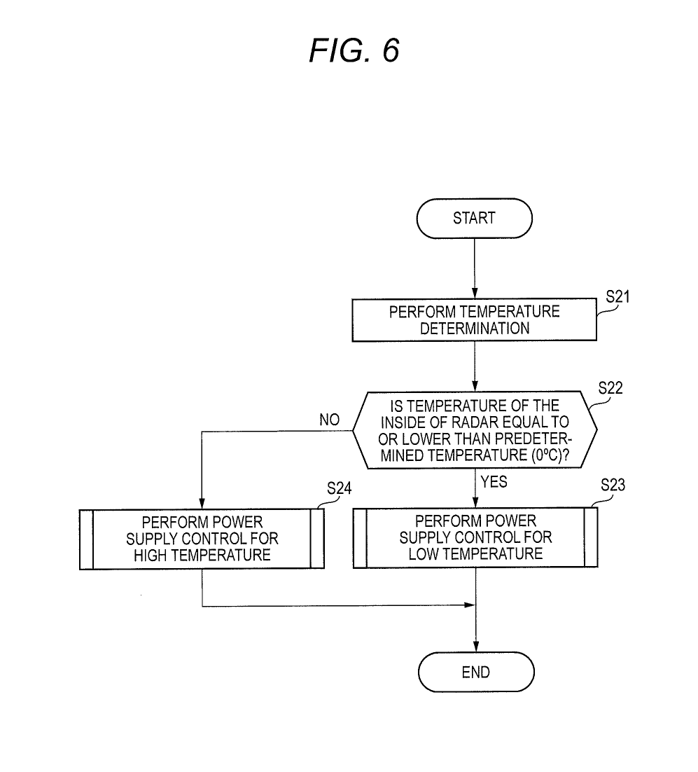

Now, a process of the transmission/reception control unit 10 of the signal processing unit 5 shown in FIG. 2 will be described. On the basis of the internal temperature of the radar device, the transmission/reception control unit 10 outputs control signals related to switching of the switches SW1 of the transmission IC 104 and the switches SW2 of the reception IC 105. On the basis of that control signals, the transmission/reception control unit 10 suppresses change of the output signal of the yaw rate sensor 102. Hereinafter, a process which is performed by the transmission/reception control unit 10 will be described with reference to FIGS. 6 to 10. This process is performed, for example, in a case where the learning unit 21 is performing zero-point level learning.

FIG. 6 is a flow chart illustrating a power supply control process according to the internal temperature of the radar device. This process is performed one time in one cycle of the target information deriving process of the radar device 1. For example, a series of processes such as generating of a transmission signal, outputting of transmission waves, receiving of reflected waves, and deriving of target information items correspond to one cycle of the target information deriving process, and one cycle is, for example, 50 msec.

In STEP S21 shown in FIG. 6, the transmission/reception control unit 10 determines the internal temperature of the radar device output the data output unit 20. In a case where the internal temperature is equal to or lower than a predetermined temperature (for example, 0° C.) (“Yes” in STEP S22), the transmission/reception control unit 10 determines that the internal temperature of the radar device is relatively low. In this case, in STEP S23, the transmission/reception control unit 10 performs power supply control for low temperature. Meanwhile, in a case where the internal temperature exceeds the predetermined temperature (“No” in STEP S22), the transmission/reception control unit 10 determines that the internal temperature of the radar device is relatively high. In this case, in STEP S24, the transmission/reception control unit 10 performs power supply control for high temperature.

<3-1. Power Supply Control for Low Temperature>

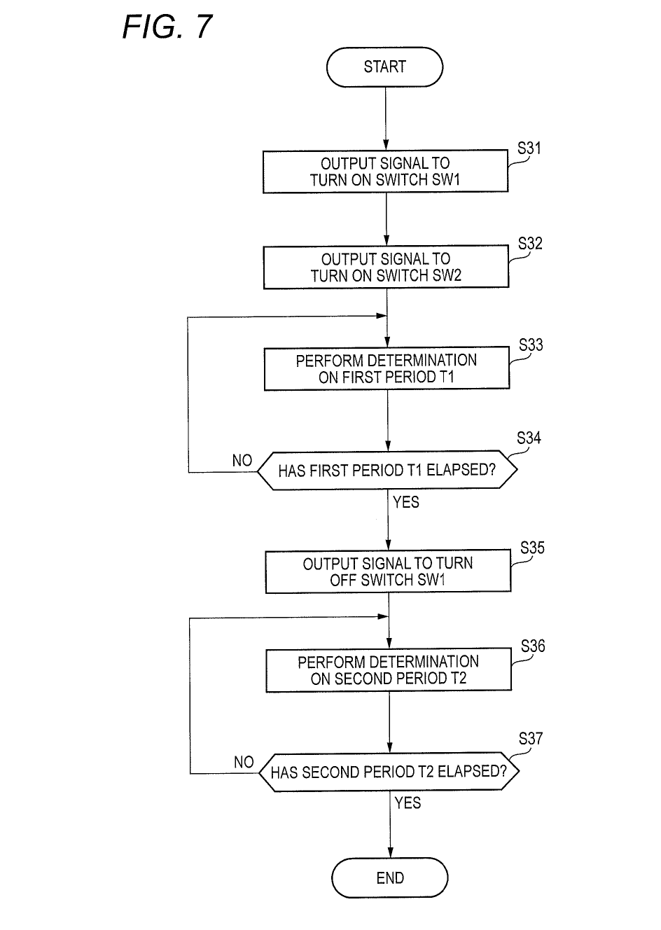

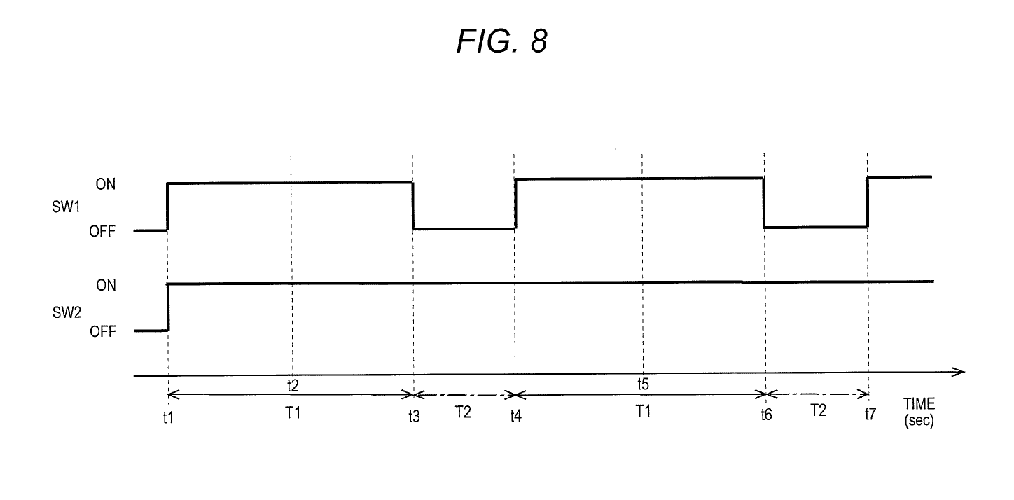

Now, specific power supply control for low temperature which is performed by the transmission/reception control unit 10 will be described with reference to FIG. 7. FIG. 7 is a flow chart illustrating the power supply control process for low temperature. Also, switching of the switches SW1 and SW2 will be described with reference to FIG. 8. FIG. 8 is a time chart illustrating timings to switch on or off the switches SW1 and SW2. In the time chart of FIG. 8, the horizontal axis represents time (in sec).

In STEP S31 shown in FIG. 7, the transmission/reception control unit 10 outputs a control signal for switching on the switches SW1, to the switches SW1. Also, in STEP S32, the transmission/reception control unit 10 outputs a control signal for switching on the switches SW2, to the switches SW2. The timings when those control signals are output are almost the same.

Therefore, at a time t1 of FIG. 8, the switches SW1 and the switches SW2 are switched on at timings which are almost the same.

Since the switches SW1 are switched on, electric power is supplied from the power supply circuit 101 to the amplifiers AP1, and a transmission signal is generated, and transmission waves TW are output. Also, since the switches SW2 are switched on, electric power is supplied from the power supply circuit 101 to the amplifiers AP2 and the mixers 13, and reception signals corresponding to reflected waves RW are mixed with the transmission signal.

In STEP S33, the transmission/reception control unit 10 determines whether a first period T1 (from the time t1 to a time t3 shown in FIG. 8) has elapsed. The first period T1 is a period when all of the switches SW1 and the switches SW2 are on. That is, the first period T1 is a period when the power supply circuit 101 supplies electric power to the transmission IC 104 and the reception IC 105.

In a case where the first period T1 has elapsed (“Yes” in STEP S34), in STEP S35, the transmission/reception control unit 10 outputs a control signal for switching off the switches SW1, to the switches SW1.

Therefore, at the time t3 of FIG. 8, the switches SW1 are switched off, whereby supply of electric power from the power supply circuit 101 to the transmission IC 104 stops. From the time t3, a power supply stop period of the transmission IC 104 starts. However, although the first period T1 has elapsed, the transmission/reception control unit 10 does not output a control signal for switching off the switches SW2. Therefore, the switches SW2 are kept in the ON state, whereby supply of electric power to the reception IC 105 continues and a power supply stop period of the reception IC 105 does not start.

Meanwhile, in a case where the ON period of the switches SW1 is shorter than the first period T1 (“No” in STEP S34), the transmission/reception control unit 10 repeatedly performs the determining process until the ON period of the switches SW1 becomes equal to or longer than the first period T1.

As described above, the transmission/reception control unit 10 keeps supply of electric power to the reception IC 105. Therefore, the switches SW2 of the reception IC 105 are kept in the ON state without being switched off, and thus change of the output voltage of the power supply circuit 101 is reduced. As a result, change of the output signal of the yaw rate sensor 102 to which electric power is supplied from the power supply circuit 101 is suppressed.

As described above, in a case where the internal temperature is equal to or lower than the predetermined temperature (for example, 0° C.), the transmission/reception control unit 10 performs control such that the power supply stop periods of the reception IC 105 (for example, a second period T2 shown in FIG. 8) become shorter than those in a case (to be described below) where the internal temperature exceeds the predetermined temperature. In other words, in a case where the internal temperature is equal to or lower than the predetermined temperature, the transmission/reception control unit 10 performs control such that the OFF periods of the switches SW2 become shorter than those in a case where the internal temperature exceeds the predetermined temperature. Therefore, even in a case where the internal temperature of the radar device is relatively low, the radar device 1 can detect information on the rotation angle of the vehicle with a high degree of accuracy, and can derive the accurate locations of targets.

Also, since the power supply stop periods of only the reception IC 105 which is one of the two ICs are shortened, and the power supply stop periods of the transmission IC 104 which is the other IC are not shortened, it is possible to suppress the internal temperature of the radar device from rising due to heating of the ICs.

Subsequently, in STEP S36, the transmission/reception control unit 10 determines whether the second period T2 (from the time t3 to time t4 shown in FIG. 8) has elapsed. The second period T2 is a period when the switches SW1 are off and the switches SW2 are on. That is, the second period T2 is a power supply stop period when the power supply circuit 101 does not supply electric power to the transmission IC 104, and is a power supply period when the power supply circuit 101 supplies electric power to the reception IC 105.

In a case where the second period T2 has elapsed (“Yes” in STEP S37), the transmission/reception control unit 10 finishes the power supply control process. Meanwhile, in a case where the OFF period of the switches SW1 is shorter than the second period T2 (“No” in STEP S37), the transmission/reception control unit 10 repeatedly performs the determining process until the OFF period of the switches SW1 becomes equal to or longer than the second period T2.

The processes of STEPS S31 to S37 of FIG. 7 as described above correspond to one cycle of the target information deriving process. In other words, the processes in the period from the time t1 to the time t4 shown in FIG. 8 correspond to one cycle of the target information deriving process. Also, processes in a period from the time t4 to a time t7 shown in FIG. 8 correspond to the next cycle, and thereafter, identical processes are repeatedly performed. In the meantime, the switches SW2 of the reception IC 105 are almost always on. Here, when the switches SW2 are referred to as being almost always on, the switches SW2 may be always on while the internal temperature is equal to or lower than the predetermined temperature, or may be instantaneously switched off and on while the internal temperature is equal to or lower than the predetermined temperature.

<3-2. Power Supply Control for High Temperature>

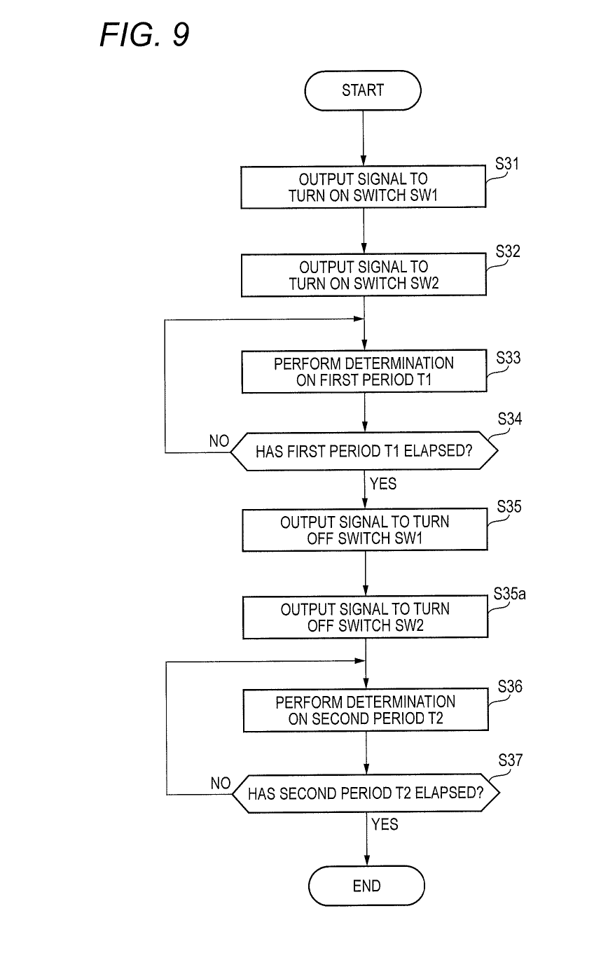

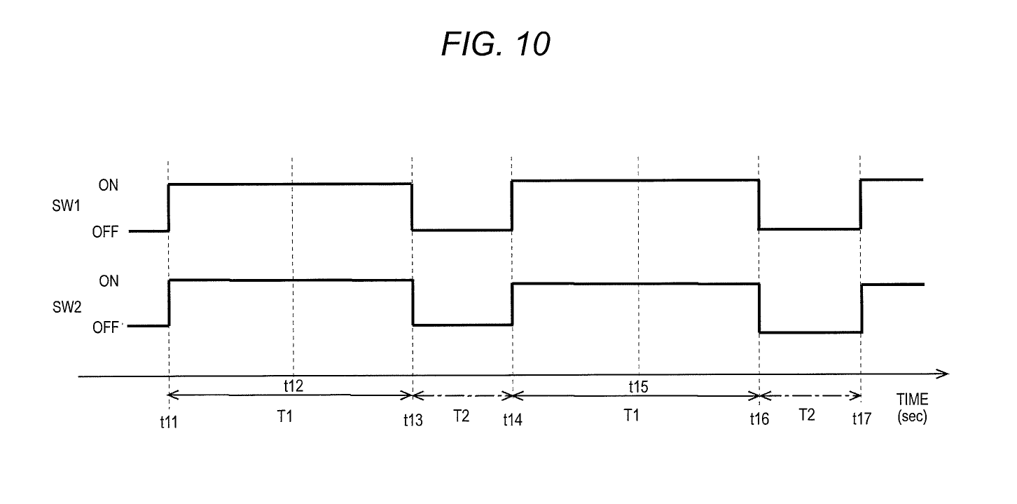

Now, specific power supply control for high temperature which is performed by the transmission/reception control unit 10 will be described with reference to FIG. 9. FIG. 9 is a flow chart illustrating the power supply control process for high temperature. Also, switching of the switches SW1 and SW2 will be described with reference to FIG. 10. FIG. 10 is a time chart illustrating timings to switch on or off the switches SW1 and SW2. In the time chart of FIG. 10, the horizontal axis represents time (in sec).

The process of FIG. 9 is almost the same as the process of FIG. 7 described above, except a part of the process. Specifically, in the process of FIG. 9, the transmission/reception control unit 10 performs the process of STEP S35a, in addition to the process of FIG. 7. The transmission/reception control unit 10 outputs a control signal for switching off the switches SW1, to the switches SW1, in STEP S35, and outputs a control signal for switching off the switches SW2, to the switches SW2, in STEP S35a. The timings when those control signals are output are almost the same.

Therefore, at a time t1 of FIG. 10, the switches SW1 and the switches SW2 are switched off at timings which are almost the same. Thereby, the transmission/reception control unit 10 stops supply of electric power to the reception IC 105. Therefore, it is possible to reduce the power consumption of the radar device 1, and it is possible to prevent heating of each IC.

Also, as described with reference to FIG. 5, in a case where the internal temperature of the radar device is relatively high, even if switching of the switches SW2 of the reception IC 105 is performed, the amount of change of the output signal is relatively small. That is, the impedance of the electrolytic capacitor connected to the power supply circuit 101 is low, and thus the amount of change of the output voltage attributable to change of current is relatively small. As a result, the amount of change of the output signal of the yaw rate sensor 102 to which electric power is supplied from the power supply circuit 101 is relatively small. Therefore, in a case where the internal temperature of the radar device exceeds the predetermined temperature, since the transmission/reception control unit 10 outputs a control signal for switching the switches SW2 of the reception IC 105 from the ON state to the OFF state, the second period T2 of FIG. 10 becomes an OFF period of the switches SW2. That is, the second period T2 becomes a power supply stop period when the power supply circuit 101 does not supply electric power to the reception IC 105.

Also, the other switching timings of the switches SW1 and SW2 shown in FIG. 10 are the same as the switching timings described with reference to FIG. 8. Further, a period from a time t11 to a time t14 shown in FIG. 10 corresponds to one cycle of the target information deriving process, and a period from the time t14 to a time t17 corresponds to the next one cycle.

As described above, in a case where the internal temperature of the radar device is relatively high, even if switching of the switches SW2 is performed regularly, the amount of change of the output signal of the yaw rate sensor 102 becomes relatively small, whereby it is possible to reduce the power consumption of the radar device 1 and it is possible to prevent heating of each IC.

<3-3. Summary>

As described above, the transmission/reception control unit 10 detects the internal temperature of the radar device, for example, in a case where the learning unit 21 is performing zero-point level learning. Then, in a case where the internal temperature is equal to or lower than the predetermined temperature, the transmission/reception control unit 10 performs control such that the power supply stop periods of the reception IC 105 becomes shorter than those in a case where the internal temperature exceeds the predetermined temperature. That is, the transmission/reception control unit 10 performs control such that the switches SW2 are almost always on. Therefore, even in a case where the internal temperature of the radar device is relatively low, the radar device 1 can detect information on the rotation angle of the vehicle with a high degree of accuracy, and can derive the accurate locations of targets.

### Second Embodiment

Now, a second embodiment will be described. In a case where the internal temperature of the radar device is equal to or lower than the predetermined temperature, a transmission/reception control unit 10 of the second embodiment performs control such that the switches SW1 of the transmission IC 104 are almost always on.

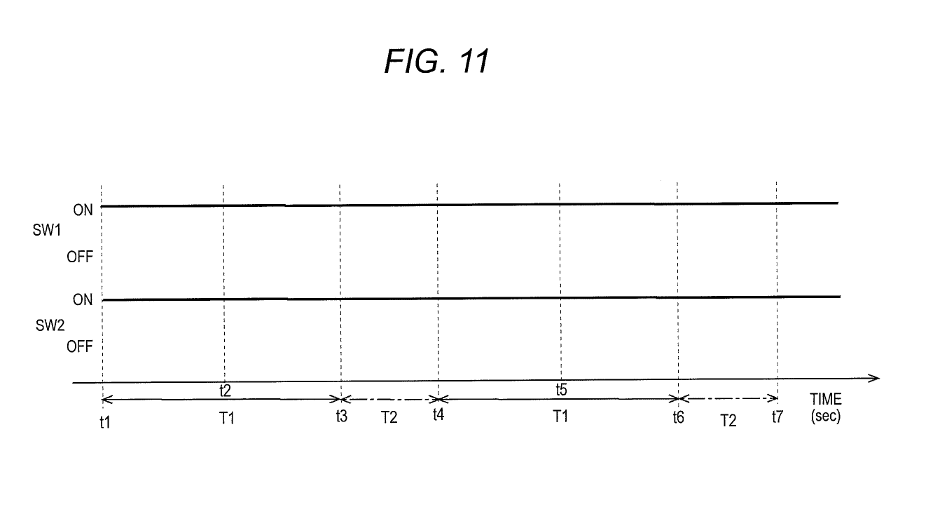

The configuration and process of a radar device 1 of the second embodiment are almost the same as those of the first embodiment, except a portion of the content of control on the switches SW1 described above. Hereinafter, the difference will be mainly described with reference to FIG. 11.

FIG. 11 is a time chart illustrating timings to switching on or off the switches SW1 and SW2 of the second embodiment.

In the first embodiment described above, as described with reference to FIG. 8, in the case where the first period T1 has elapsed, the transmission/reception control unit 10 outputs a control signal for switching off the switches SW1, to the switches SW1. In contrast, the transmission/reception control unit 10 of the second embodiment does not output a control signal for switching off the switches SW1 although the first period T1 has elapsed. Therefore, since the switches SW1 are kept in the ON state, whereby supply of electric power to the transmission IC 104 continues and a power supply stop period of the transmission IC 104 does not start.

As described above, the transmission/reception control unit 10 keeps supply of electric power to the transmission IC 104. Therefore, switching of the switches SW2 of the reception IC 105 is not performed, and thus change of the output voltage of the power supply circuit 101 is further reduced. As a result, change of the output signal of the yaw rate sensor 102 to which electric power is supplied from the power supply circuit 101 is further suppressed.

As described above, in a case where the internal temperature is equal to or lower than the predetermined temperature (for example, 0° C.), the transmission/reception control unit 10 performs control such that the power supply stop periods of the transmission IC 104 become shorter than those in a case where the internal temperature exceeds the predetermined temperature. In other words, in a case where the internal temperature is equal to or lower than the predetermined temperature, the transmission/reception control unit 10 performs control such that the OFF periods of the switches SW1 become shorter than those in a case where the internal temperature exceeds the predetermined temperature. Therefore, even in a case where the internal temperature of the radar device is relatively low, the radar device 1 can detect information on the rotation angle of the vehicle with a higher degree of accuracy, and can derive the accurate locations of targets.

<Modifications>

Although the embodiments of the present invention have been described above, the present invention is not limited to the above described embodiments, and can be modified in various forms. Hereinafter, these modifications will be described. All forms including the above described embodiments and the following embodiments to be described below can be appropriately combined.

In the first embodiment described above, the transmission/reception control unit 10 performs power supply control depending on the internal temperature of the radar device, for example, when the learning unit 21 is performing zero-point level learning. In contrast to this, the transmission/reception control unit 10 may perform power supply control depending on the internal temperature of the radar device when any other process is being performed, not when the learning unit 21 is performing zero-point level learning. For example, when the target information deriving process is being performed, the transmission/reception control unit 10 can perform power supply control depending on the internal temperature of the radar device. In this case, it is possible to reduce change of the output signal of the yaw rate sensor 102 which is used in the target information deriving process.

Also, in the first embodiment described above, since the power consumption of the reception IC 105 is larger than the power consumption of the transmission IC 104, control is performed such that switching of the switches SW1 of the transmission IC 104 is performed regularly and the switches SW2 of the reception IC 105 are almost always on, whereby change of the output voltage of the power supply circuit 101 is reduced. In contrast, in a case where the power consumption of the transmission IC 104 is larger than the power consumption of the reception IC 105, control may be performed such that switching of the switches SW2 of the reception IC 105 is performed regularly and the switches SW1 of the transmission IC 104 are almost always on.

Also, in each embodiment described above, in a case where the internal temperature is equal to or lower than the predetermined temperature, the transmission/reception control unit 10 performs control such that the power supply stop periods of the reception IC 105 become shorter than those in a case where the internal temperature exceeds the predetermined temperature. Besides, in a case where the internal temperature is a specific temperature, the transmission/reception control unit 10 may perform control such that the power supply stop periods of the reception IC 105 become shorter those corresponding to the previous temperature. The specific temperature is not limited to a relatively low temperature (for example, −30° C.), and may be a relatively high temperature (for example, +30° C.). Due to the characteristics of individual components connected to the power supply circuit 101, at a relatively high temperature, in a case where the output voltage changes, with this change of the output voltage, the output signal of the yaw rate sensor 102 also changes relatively significantly. For this reason, in the case where the internal temperature is the specific temperature which influences the amplitude of the output signal of the yaw rate sensor 102, the transmission/reception control unit 10 performs control such that the power supply stop periods of the reception IC 105 become shorter than those corresponding to the previous temperature, whereby it is possible to suppress change of the output signal of the yaw rate sensor 102.

Also, in each embodiment described above, the radar device is provided at the front portion (for example, the inside of the front bumper) of the vehicle. In contrast to this, the radar device 1 may be provided at one or more places of rear portions (for example, a rear bumper), left portions (for example, a left door mirror), and right portions (for example, a right door mirror) of the vehicle as long as it is possible to output a transmission wave from each corresponding place to the outside of the vehicle.

Also, in each above described embodiment, outputting from the transmitting antennae may use any method capable of detecting target information items, such as electric waves, ultrasonic waves, light, and lasers.

Also, in each above described embodiment, the radar device may be used in other devices besides vehicles. For example, the radar device may be used in an aircraft, a ship, and so on.

Also, in each above described embodiment, various functions are implemented in a software wise by arithmetic processing of the CPU according to programs. However, some of those functions may be implemented by electric hardware circuits. Also, conversely, some of functions which are implemented by hardware circuits may be implemented in a software wise.

What is claimed is:

1. A radar device comprising:
a receiving circuit that mixes a transmission signal with reception signals;
a first detecting unit that detects information on a rotation angle of a vehicle equipped with the radar device, on the basis of an output signal of a yaw rate sensor;
a second detecting unit that detects an internal temperature of the radar device on the basis of an output signal from a temperature sensor;
a power supply circuit that supplies electric power to the receiving circuit and the yaw rate sensor; and
a control unit that repeatedly sets power supply periods and power supply stop periods of the receiving circuit,
wherein, in a case where the internal temperature is equal to or lower than a predetermined temperature, the control unit performs control such that the power supply stop periods of the receiving circuit become shorter than those in a case where the internal temperature exceeds the predetermined temperature.

2. The radar device according to claim 1, wherein:
the receiving circuit has first switches which are switched on or off according to whether electric power is supplied to the receiving circuit, and
in a case where the internal temperature is equal to or lower than the predetermined temperature, the control unit performs control such that OFF periods of the first switches become shorter than those in a case where the internal temperature exceeds the predetermined temperature.

3. The radar device according to claim 1, further comprising:
a transmitting circuit that generates the transmission signal,
wherein the power supply circuit supplies electric power to the transmitting circuit,
the control unit repeatedly sets power supply periods and power supply stop periods of the transmitting circuit, and
in a case where the internal temperature is equal to or lower than a predetermined temperature, the control unit performs control such that the power supply stop periods of the transmitting circuit become shorter than those in a case where the internal temperature exceeds the predetermined temperature.

4. The radar device according to claim 3, wherein:
the transmitting circuit has second switches which are switched on or off according to whether electric power is supplied to the transmitting circuit, and
in a case where the internal temperature is equal to or lower than the predetermined temperature, the control unit performs control such that OFF periods of the second switches become shorter than those in a case where the internal temperature exceeds the predetermined temperature.

5. The radar device according to claim 1, further comprising:
a learning unit that learns a correction value for correcting information on the rotation angle, on the basis of information on the rotation angle detected by the first detecting unit,
wherein, in a case of learning the correction value, the control unit shortens the power supply stop periods of the receiving circuit.

6. A signal processing method of a radar device which includes a receiving circuit that mixes a transmission signal with reception signals, a yaw rate sensor that has individual devices, and a power supply circuit that supplies electric power to the individual devices, comprising:
a step (a) of detecting information on the rotation angle of a vehicle equipped with the radar device, on the basis of an output signal of the yaw rate sensor;
a step (b) of detecting the internal temperature of the radar device on the basis of an output signal from a temperature sensor; and
a step (c) of repeatedly setting power supply periods and power supply stop periods of the receiving circuit,
wherein, in the step (c), in a case where the internal temperature is equal to or lower than a predetermined temperature, the power supply stop periods of the receiving circuit are set so as to be shorter than those in a case where the internal temperature exceeds the predetermined temperature.

7. A radar device comprising:
a receiving circuit that mixes a transmission signal with reception signals;
a first detecting unit that detects information on the rotation angle of a vehicle equipped with the radar device, on the basis of an output signal of a yaw rate sensor;
a second detecting unit that detects the internal temperature of the radar device on the basis of an output signal from a temperature sensor;
a power supply circuit that supplies electric power to the receiving circuit and the yaw rate sensor; and
a control unit that repeatedly sets power supply periods and power supply stop periods of the receiving circuit,
wherein, in a case where the internal temperature is a specific temperature, the control unit performs control such that the power supply stop periods of the receiving circuit become shorter than those corresponding to the previous internal temperature.
